(19) United States
(12) Patent Application Publication
(10) Pub. No.: US 2025/0130927 A1
(43) Pub. Date: Apr. 24, 2025

(54) AUTOMATED GENERATION OF SOFTWARE APPLICATION TEST CASES FOR EVALUATION OF SOFTWARE APPLICATION ISSUES

(71) Applicant: Dell Products L.P., Round Rock, TX (US)

(72) Inventors: Kiko Nan Wang, Chengdu (CN); Michael Chen, Chengdu (CN); Jessica Jing Ye, Chengdu (CN)

(21) Appl. No.: 18/501,187

(22) Filed: Nov. 3, 2023

(30) Foreign Application Priority Data
Oct. 23, 2023 (CN) 202311383108.9

(51) Int. Cl. G06F 11/36

(52) U.S. Cl. CPC G06F 11/3684

(57) ABSTRACT

Techniques are provided for automated generation of software application test cases for evaluation of software application issues. One method comprises obtaining a first mapping of log event templates, related to log events in a software application log, to respective log event template vectors; obtaining a second mapping of test step vectors, generated using the log event template vectors, to respective test step functions, wherein a given test step vector comprises one or more of the log event template vectors; in response to obtaining information characterizing a software application issue: generating test step vector representations of the information characterizing the software application issue, using the first mapping; mapping the test step vector representations of the information to respective test step functions using the second mapping; and generating a test case logic flow to evaluate the software application issue using the mapped test step functions.

### RELATED APPLICATION(S)

The present application claims priority to Chinese Patent Application No. 202311383108.9, filed Oct. 23, 2023, and entitled “Automated Generation of Software Application Test Cases for Evaluation of Software Application Issues,” which is incorporated by reference herein in its entirety.

### BACKGROUND

It is often necessary to generate test cases to evaluate reported issues related to an operation of a given software product. Conventional approaches for evaluating reported software issues, however, typically include generating test cases using time-consuming and error-prone manual techniques. Additionally, such manual techniques can result in test cases that may not properly evaluate the operation of the software product, which can lead to reduced software quality.

### SUMMARY

Illustrative embodiments of the disclosure provide techniques for automated generation of software application test cases for evaluation of software application issues, such as bugs and errors. An exemplary method comprises obtaining a first mapping of a plurality of log event templates, related to one or more log events in one or more software logs, generated by executing a software application on one or more of a plurality of information technology assets of an information technology infrastructure, to respective ones of vector representations of the log event templates; obtaining a second mapping of a plurality of test step vector representations, generated using the vector representations of the log event templates, to respective ones of a plurality of test step functions, wherein a given test step vector representation comprises one or more of the vector representations of the log event templates, and wherein the second mapping is generated by analyzing an execution of a plurality of test steps related to the software application in an execution history of the one or more software logs; in response to obtaining information characterizing a software issue related to the software application: generating one or more test step vector representations of the information characterizing the software issue, using the first mapping; mapping the one or more test step vector representations of the information characterizing the software issue to respective ones of a plurality of test step functions using the second mapping; and automatically generating a test case logic flow to evaluate the software issue related to the software application using the mapped test step functions.

Illustrative embodiments can provide significant advantages relative to conventional techniques for evaluating software applications. For example, problems associated with time-consuming and error-prone manual software evaluation techniques are overcome in one or more embodiments by automatically generating one or more software application test cases for a given software application by analyzing one or more software logs associated with historical executions of the given software application.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for automated generation of software application test cases for evaluation of software application issues in an illustrative embodiment;

FIG. 2 shows a text vectorization technique using bag-of-words natural language processing in an illustrative embodiment;

FIG. 3 shows examples of different product types having different associated test log formats in an illustrative embodiment;

FIG. 4 shows log event template dictionaries used for converting log events into log event templates in an illustrative embodiment;

FIG. 5 illustrates an automated generation of software application test cases for evaluation of software application issues in an illustrative embodiment;

FIG. 6 illustrates an exemplary log event template dictionary in an illustrative embodiment;

FIG. 7 illustrates an exemplary test step vector-to-test step function mapping table in an illustrative embodiment;

FIG. 8 illustrates a processing of one or more raw software logs to generate the test step vector-to-test step function mapping table of FIG. 7 in an illustrative embodiment;

FIG. 9 illustrates a processing of one or more customer software logs to generate a test case logic flow that evaluates a reported software issue related to a given software application in an illustrative embodiment;

FIG. 10 illustrates an exemplary customer test step vector-to-test step function mapping table in an illustrative embodiment;

FIG. 11 is a flow diagram illustrating an exemplary implementation of a process for automated generation of software application test cases for evaluation of software application issues, according to an embodiment; and

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

As noted above, it is often necessary to generate test cases to evaluate reported issues with respect to an operation of the software product. It is often difficult, however, to reproduce such issues when the issues are encountered and reported by customers or other non-technical users of a given software product. For example, the customer's report may not be clear enough to provide a clear understanding of the software issue. A customer may not provide enough information (e.g., steps to reproduce a given software issue, execution environment configuration, screenshots or related error messages) to reproduce a given software bug or other issue. This can make it difficult for a testing team to understand the issue and reproduce the issue in a controlled environment.

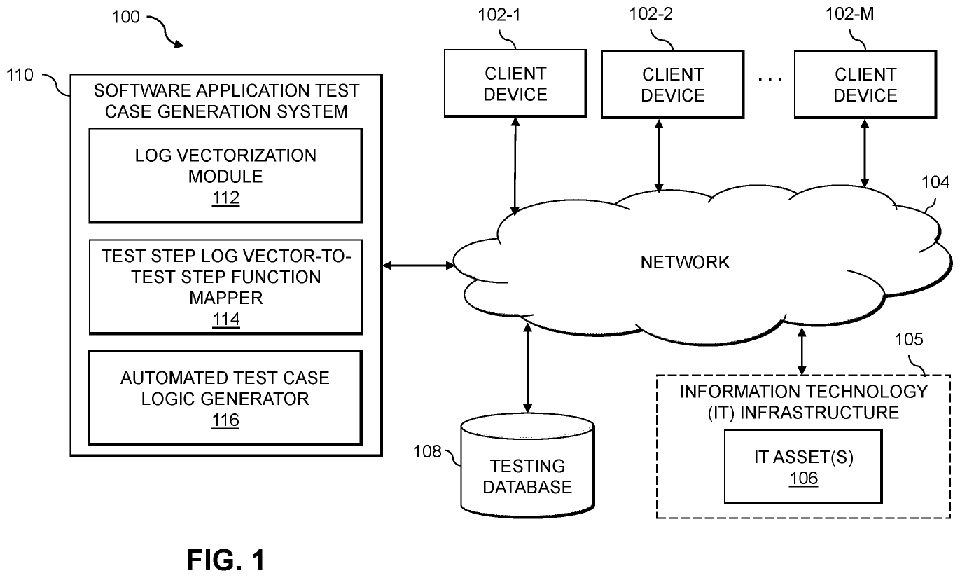

FIG. 1 shows an information processing system 100 configured in accordance with an illustrative embodiment. The information processing system 100 is assumed to be built on at least one processing platform and provides functionality for automated generation of software application test cases for evaluation of software application issues. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, a testing database 108, and a software application test case generation system 110. The IT assets 106 may comprise physical and/or virtual computing resources in the IT infrastructure 105. Physical computing resources may include physical hardware such as servers, host devices, storage systems, networking equipment, Internet of Things (IoT) devices, other types of processing and computing devices including desktops, laptops, tablets, smartphones, etc. Virtual computing resources may include virtual machines (VMs), containers, etc.

The IT assets 106 of the IT infrastructure 105 may host software applications that are utilized by respective ones of the client devices 102, such as in accordance with a client-server computer program architecture. In some embodiments, the software applications comprise web applications designed for delivery from assets in the IT infrastructure 105 to users (e.g., of client devices 102) over the network 104. Various other examples are possible, such as where one or more software applications are used internal to the IT infrastructure 105 and not exposed to the client devices 102. It should be appreciated that, in some embodiments, some of the IT assets 106 of the IT infrastructure 105 may themselves be viewed as applications or more generally software or hardware that is to be evaluated. For example, individual ones of the IT assets 106 that are virtual computing resources implemented as software containers may represent software that is to be evaluated. As another example, individual ones of the IT assets 106 that are physical computing resources may represent hardware devices that are to be evaluated.

The software application test case generation system 110 utilizes various information stored in the testing database 108, such as execution logs providing information obtained from executions of a given software application, to automatically generate software application test cases to reproduce a given software application issue. In some embodiments, the software application test case generation system 110 is used for an enterprise system. For example, an enterprise may subscribe to or otherwise utilize the software application test case generation system 110 to automatically generate software application test cases to reproduce software application issues. As used herein, the term “enterprise system” is intended to be construed broadly to encompass any group of systems or other computing devices. For example, the IT assets 106 of the IT infrastructure 105 may provide a portion of one or more enterprise systems. A given enterprise system may also or alternatively include one or more of the client devices 102. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The testing database 108, as discussed above, is configured to store and record various information, such as execution logs providing information obtained from executions of a given software application, which is used by the software application test case generation system 110 to automatically generate software application test cases to reproduce a given software application issue. Such information may include, but is not limited to, information regarding execution of one or more software applications, test cases, testing objectives, testing points, test coverage, testing plans, etc. The testing database 108 in some embodiments is implemented using one or more storage systems or devices associated with the software application test case generation system 110. In some embodiments, one or more of the storage systems utilized to implement the testing database 108 comprise a scale-out all-flash content addressable storage array or other type of storage array.

The term “storage system” as used herein is therefore intended to be broadly construed and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the software application test case generation system 110, as well as to support communication between the software application test case generation system 110 and other related systems and devices not explicitly shown.

The client devices 102 are configured to access or otherwise utilize the IT infrastructure 105. In some embodiments, the client devices 102 are assumed to be associated with users that execute one or more software applications and report bugs or other issues encountered with such executions. In other embodiments, the client devices 102 are assumed to be associated with system administrators, IT managers or other authorized personnel responsible for managing the IT assets 106 of the IT infrastructure 105 (e.g., where such management includes performing testing of the IT assets 106, or of applications or other software that runs on the IT assets 106). For example, a given one of the client devices 102 may be operated by a user to access a graphical user interface (GUI) provided by the software application test case generation system 110 to manage testing plans (e.g., create, review, execute, etc.). The software application test case generation system 110 may be provided as a cloud service that is accessible by the given client device 102 to allow the user thereof to manage testing plans. In some embodiments, the IT assets 106 of the IT infrastructure 105 are owned or operated by the same enterprise that operates the software application test case generation system 110 (e.g., where an enterprise such as a business provides support for the assets it operates). In other embodiments, the IT assets 106 of the IT infrastructure 105 may be owned or operated by one or more enterprises different than the enterprise which operates the software application test case generation system 110 (e.g., a first enterprise provides support for assets that are owned by multiple different customers, business, etc.). Various other examples are possible.

In other embodiments, the software application test case generation system 110 may provide support for testing of the client devices 102, instead of or in addition to providing support for the IT assets 106 of the IT infrastructure 105. For example, the software application test case generation system 110 may be operated by a hardware vendor that manufactures and sells computing devices (e.g., desktops, laptops, tablets, smartphones, etc.), and the client devices 102 represent computing devices sold by that hardware vendor. The software application test case generation system 110 may also or alternatively be operated by a software vendor that produces and sells software (e.g., applications) that runs on the client devices 102. The software application test case generation system 110, however, is not required to be operated by any single hardware or software vendor. Instead, the software application test case generation system 110 may be offered as a service to provide support for computing devices or software that are sold by any number of hardware or software vendors. The client devices 102 may subscribe to the software application test case generation system 110, so as to provide support for testing and/or evaluation of the client devices 102 or software running thereon. Various other examples are possible.

In some embodiments, the client devices 102 may implement host agents that are configured for automated transmission of information regarding a state of the client devices 102 (e.g., such as in the form of testing and/or execution logs periodically provided to the testing database 108 and/or the software application test case generation system 110). Such host agents may also or alternatively be configured to automatically receive from the software application test case generation system 110 commands to execute remote actions (e.g., to run various test steps and/or test cases on the client devices 102 and/or the IT assets 106 of the IT infrastructure 105). Host agents may similarly be deployed on the IT assets 106 of the IT infrastructure 105.

It should be noted that a “host agent” as this term is generally used herein may comprise an automated entity, such as a software entity running on a processing device. Accordingly, a host agent need not be a human entity.

The software application test case generation system 110 in the FIG. 1 embodiment is assumed to be implemented using at least one processing device. Each such processing device generally comprises at least one processor and an associated memory, and implements one or more functional modules or logic for controlling certain features of the software application test case generation system 110. In the FIG. 1 embodiment, the software application test case generation system 110 comprises a log vectorization module 112, a test step log vector-to-test step function mapper 114 and an automated test case logic generator 116. The log vectorization module 112 is configured to obtain a set of software logs generated by executing one or more software applications on, for example, one or more of the IT assets 106 of the IT infrastructure 105 or on a client device 102. The log vectorization module 112 is also configured to parse the set of software logs to generate a set of log event templates for testing actions performed during execution of the one or more software applications on the one or more IT assets 106 or client devices 102. The log vectorization module 112 is further configured to generate vector representations of the plurality of log events utilizing the generated set of log event templates. The test step log vector-to-test step function mapper 114 is configured to perform, utilizing one or more machine learning-based algorithms, a mapping of one or more test step vector representations of a software issue to respective ones of test step functions. The automated test case logic generator 116 is configured to generate, using the mapped test step functions, a test case logic flow to evaluate a software issue related to a given software application. The software application test case generation system 110 is further configured, either directly or via one or more of the client devices 102, to execute the test case logic flow on one or more of the IT assets 106 of the IT infrastructure 105.

It is to be appreciated that the particular arrangement of the client devices 102, the IT infrastructure 105 and the software application test case generation system 110 illustrated in the FIG. 1 embodiment is presented by way of example only, and alternative arrangements can be used in other embodiments. As discussed above, for example, the software application test case generation system 110 (or portions of components thereof, such as one or more of the log vectorization module 112, the test step log vector-to-test step function mapper 114 and the automated test case logic generator 116) may in some embodiments be implemented internal to one or more of the client devices 102 and/or the IT infrastructure 105.

At least portions of the log vectorization module 112, the test step log vector-to-test step function mapper 114 and the automated test case logic generator 116 may be implemented at least in part in the form of software that is stored in memory and executed by a processor.

The software application test case generation system 110 and other portions of the information processing system 100, as will be described in further detail below, may be part of cloud infrastructure.

The software application test case generation system 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the testing database 108 and the software application test case generation system 110 or components thereof (e.g., the log vectorization module 112, the test step log vector-to-test step function mapper 114 and the automated test case logic generator 116) may be implemented on respective distinct processing platforms, although numerous other arrangements are possible. For example, in some embodiments at least portions of the software application test case generation system 110 and one or more of the client devices 102, the IT infrastructure 105 and/or the testing database 108 are implemented on the same processing platform. A given client device (e.g., client device 102-1) can therefore be implemented at least in part within at least one processing platform that implements at least a portion of the software application test case generation system 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the testing database 108 and the software application test case generation system 110, or portions or components thereof, to reside in different data centers. Numerous other distributed implementations are possible. The software application test case generation system 110 can also be implemented in a distributed manner across multiple data centers.

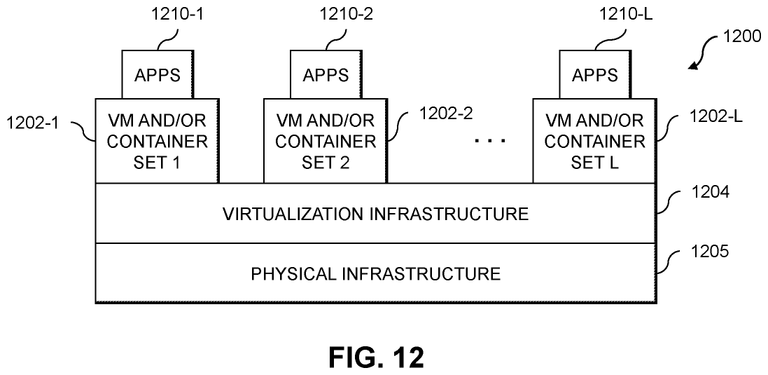

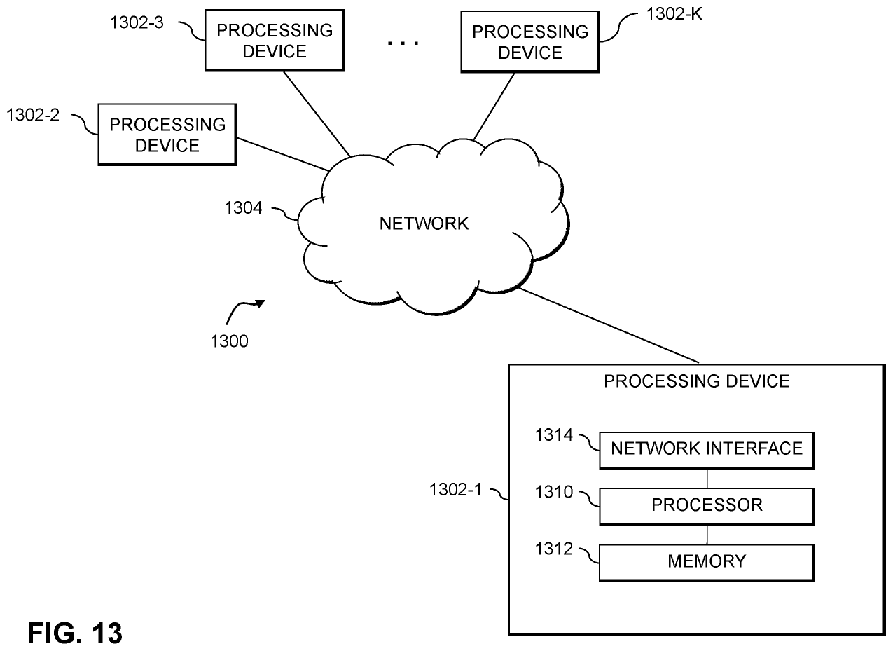

Additional examples of processing platforms utilized to implement the software application test case generation system 110 and other components of the information processing system 100 in illustrative embodiments will be described in more detail below in conjunction with FIGS. 12 and 13.

It is to be appreciated that these and other features of illustrative embodiments are presented by way of example only and should not be construed as limiting in any way.

It is to be understood that the particular set of elements shown in FIG. 1 for automated generation of software application test cases for evaluation of software application issues is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only and should not be construed as limiting in any way.

Illustrative embodiments provide techniques for automatically generating software application test cases to evaluate software application issues. In some embodiments, the disclosed software application test case generation techniques are based at least in part on analysis of system testing logs (also referred to simply as “software logs”) to improve evaluation of software application issues.

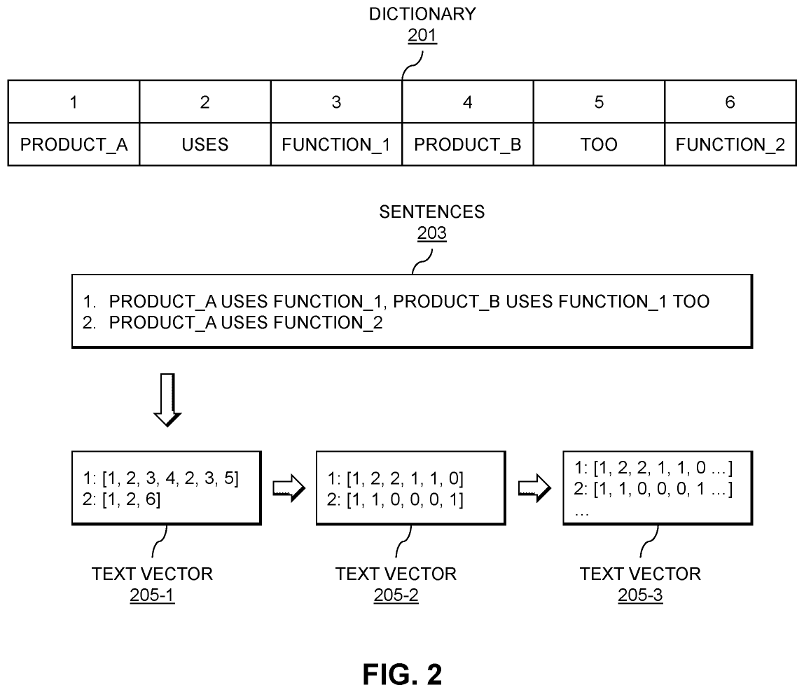

Software log vectorization will now be described. Various NLP methods may be used for text vectorization, including bag-of-words, word2vec, etc. Text vectorization models may create an index of each word, and then use such indexes for representing sentences. FIG. 2, for example, shows a process for a bag-of-words text vectorization, in which a dictionary 201 is generated from a set of sentences 203, which are converted into sets of text vectors 205-1, 205-2 and 205-3. The text vector 205-1 has the problem that the different sentences have different vector dimensions, which is not suitable for input to machine learning algorithms. The text vector 205-1 can thus be transformed to text vector 205-2, which includes 6-dimension vectors for each of the sentences (e.g., using each word frequency in one sentence instead of index of words). This is used for bag-of-words text vectorization. Word2vec may be used because bag-of-words text vectorization cannot reflect the word relationships, and a human being word corpus is voluminous which induces vector dimensions that are too large to be feasibly calculated in any algorithm. In a system evaluation environment, the software logs are semi-structured and have limited word description. Time sequence is also important to software logs. In some embodiments, a modified bag-of-words text vectorization approach is used which eliminates its disadvantages such that is suitable for application in log-based test case generation scenarios.

Individual words in software logs typically do not always make sense (e.g., they are not in a human-readable form). One log sentence (e.g., a row or entry in a software log) can be looked at or considered as a log event. The software log feature is dependent not only on individual log events, but also on a log event sequence, frequency, inter-arrival time (e.g., mean inter-arrival time), time-interval spread, etc. Conventional log vectorization models cannot avoid coordinate transformations (e.g., from words to logs, and logs to sequences), and also have a high computing cost (e.g., for training) which may be prohibitive for large-scale testing environments. Conventional log vectorization models, however, which may be designed for log anomaly detection, may abstract features in a different manner than an abstraction for test case generation.

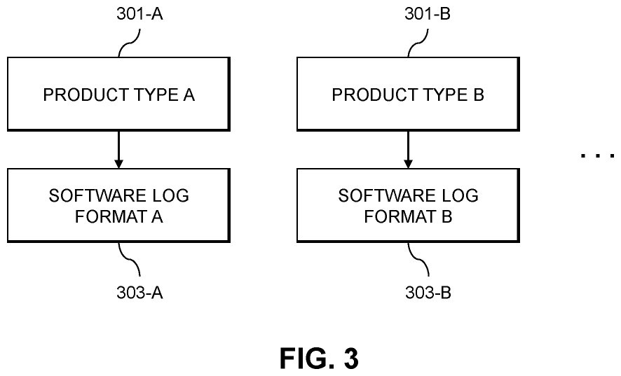

Different software logs (e.g., for different products) may have their own formats and templates. FIG. 3, for example, shows two product types 301-A and 301-B having different associated software log formats 303-A and 303-B. The product type 301-A, for example, may be an Internet server having an associated software log format 303-A that is focused on information transformation. The product type 301-B may be a storage-related product having an associated software log format 303-B that is focused on logic events. Various other examples are possible. Identifying the log format and associated log template to use for a particular software log according to its log structure is important for pre-processing.

In some embodiments, a log vectorization process extracts constant parts from log items. Consider, as an example, the following log item:

$$“ A\_QA \_ACTION [ \text{} DEACTIVATE : Appliance - WX - D 0579 - node - A - PM ] Finished - Deactivating Appliance - WX - D 0579 - node - A - PM : pid = 16752 uptime = 1 \text{/1} 1 / 2021 \; 13 : 33 : 52 DeactivateSig = 6 , ”$$

which will be structured into the following log event template by extracting the constant parts:

$$“ * \_QA \_ACTION [ DEACTIVATE : * - PM ] Finished - Deactivating \\ Appliance - * - PM : pid = * uptime = * DeactivateSig = 6 ” .$$

A software log can be transformed into a combination of several log event templates, with the general principle of the log event templates being that variables (e.g., numbers, object values, etc.) are ignored while retaining the logic and other portions (e.g., constant portions) of the log event. The process of parsing software logs to generate log event templates can be represented as follows:

$$LT = [ \begin{matrix}A ( {l}_{1} ) \\ ⋮ \\ A ( {l}_{N} )\end{matrix} ] = [ \begin{matrix}{ET}_{1} \\ {ET}_{2} \\ ⋮ \\ {ET}_{3} \\ ⋮ \\ {ET}_{N}\end{matrix} ] ,$$

where l denotes one line of a raw log message, N denotes the total number of lines of the raw log, lᵢ denotes the ith line of the raw log, where 1≤i≤N, A denotes a function which is used to transfer each line to a log event template, as described above, ET denotes a log event template, and LT denotes a log template comprised of a set of log event templates.

To reproduce a reported software issue or bug, it is often important to determine the test steps that will trigger the original problem. From a log perspective, one test step or action maps to a chunk of log messages, which includes a detail command as well as a related product reaction sequence. Therefore, in at least some embodiments, a vectorization of these chunks of log messages is useful to identify suitable test steps to reproduce a reported software issue.

A given software log may be divided into one or more chunks that include several log steps (e.g., log events). The given software log may be divided, for example, by identifying keywords, such as “action.” Such keywords may be determined as part of a design phase of a given software application. It is assumed that there are m test step logs in a given log and the window size can be expressed as follows:

$$W = [ {W}_{1} , {W}_{2} , {W}_{3} , … {W}_{m} ] ,$$

where the window size determines the length of individual test step logs (comprised of multiple lines of log data or log events). There are m log chunks in a given software log, each corresponding to a particular test step log. The ith test step log, lₛᵢ, comprises the following Wᵢ, log messages:

$${l}_{1 + {\sum }_{j = 0}^{i - 1} {W}_{j}} , {l}_{2 + {\sum }_{j = 0}^{i - 1} {W}_{j}} , {l}_{3 + {\sum }_{j = 0}^{i - 1} {W}_{j}} … {l}_{{W}_{i} + {\sum }_{j = 0}^{i - 1} {W}_{j}} .$$

Each log message in a given test step log can be parsed into a log event template. As a result, the test step log can be parsed to a list of log event templates. The log event position in a larger list provides an indication of the sequence of the log events. The ith test step log, lₛᵢ, may be expressed as follows:

$$A ( {l}_{si} ) = [ \begin{matrix}A ( {l}_{1 + {\sum }_{j = 0}^{i - 1} {W}_{j}} ) \\ ⋮ \\ A ( {l}_{{W}_{i} + {\sum }_{j = 0}^{i - 1} {W}_{j}} )\end{matrix} ] = [ \begin{matrix}{ET}_{1 + {\sum }_{j = 0}^{i - 1} {W}_{j}} \\ {ET}_{2 + {\sum }_{j = 0}^{i - 1} {W}_{j}} \\ ⋮ \\ {ET}_{5 + {\sum }_{j = 0}^{i - 1} {W}_{j}} \\ ⋮ \\ {ET}_{{W}_{i} + {\sum }_{j = 0}^{i - 1} {W}_{j}}\end{matrix} ] = {LST}_{i} ∈ LT ( 1 \leq i \leq m ) ,$$

where l denotes one line of a raw log message, Isi denotes the ith test step log, where, 1≤i≤m, Wᵢ denotes the log window size of the ith test step log, W denotes the window size set of one test log, m denotes the number of test steps in one test log, A is an abstract function used to transfer each line in a software log to a log event template, as described above, ET denotes a log event template and LST; denotes the ith test step log template.

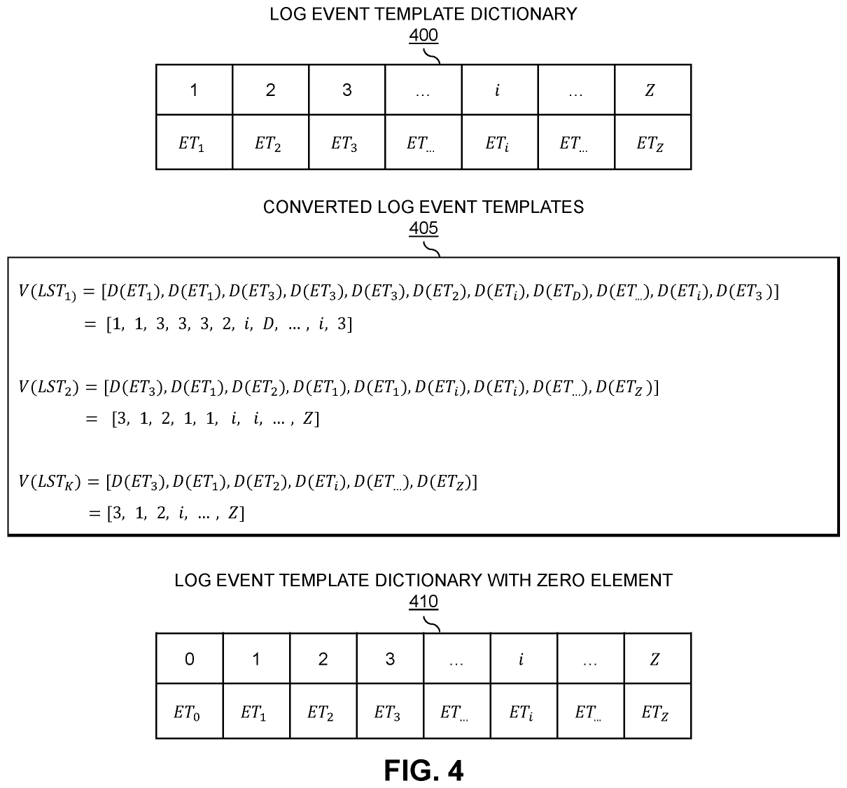

The process for log vector generation may include creating a log event template dictionary (1≤i≤Z), where Z is the number of unique log event templates, and translating the log vent template using the log event template dictionary, denoted as D, as shown in log event template dictionary 400 of FIG. 4. FIG. 4 also shows examples of log event templates 405 converted using the dictionary and the function D. The different lengths of the log event templates 405 reflect that the lengths of the raw log messages are different. The maximum length of the raw log messages may be determined according to:

$$X = Maximum ( {W}_{k} ) ( 1 \leq k \leq Z ) .$$

Log event templates shorter than the maximum length may be filled out using 0 values, so the dictionary may add a 0 element as shown in the table 410 of FIG. 4. Each log template can be vectorized according to:

$$V ( {LST}_{k} ) = \{ \begin{matrix}[ {D ( {ET}_{i} )}_{1} , … , {D ( {ET}_{i} )}_{{W}_{k}} ] for ( {W}_{k} = X ) \\ \begin{matrix}[ D {( {ET}_{i} )}_{1} , … , {D ( {ET}_{i} )}_{{W}_{k}} , 0 , 0 , 0 , 0 with number ( X - {W}_{k} ) ] \\ for ( {W}_{k} < X )\end{matrix}\end{matrix}$$

where LSTₖ denotes the kth test step log template, 1≤k≤m; V(LSTₖ) denotes a vector representation of the kth test step log template and V(LSTₖ) belongs to the test step log vector space T; Z indicates the length of a unique log event template set, and X denotes the total lines of the longest test step log template. D denotes the function for translating log event templates to a vector utilizing the created log event template dictionary 400. ET denotes a log event template, and i denotes the ith log event template, where 1≤i≤Z. Wₖ denotes the total number of lines of the kth test step log template. The test step log vectors can naturally show the test events sequence, and the dimension of a log vector is X, which should not be a voluminous un-calculated number. The dictionary capacity may also be customized such that it is acceptable in different product areas. For example, if the longest test step log template has a length of 16 lines, then X is equal to 16. If a given test step has a length, Wₖ, of five lines, then Wₖ meets the condition that Wₖ<X, and the second expression above is used, where 11 ((X−Wₖ)=(16−5)) zeroes are inserted, as follows: [3, 2, 2, 7, 1, 0, 0, 0, 0, 0, 0, 0, 0, 0, 0, 0], such that the vector representations of the test step log template will have the same length.

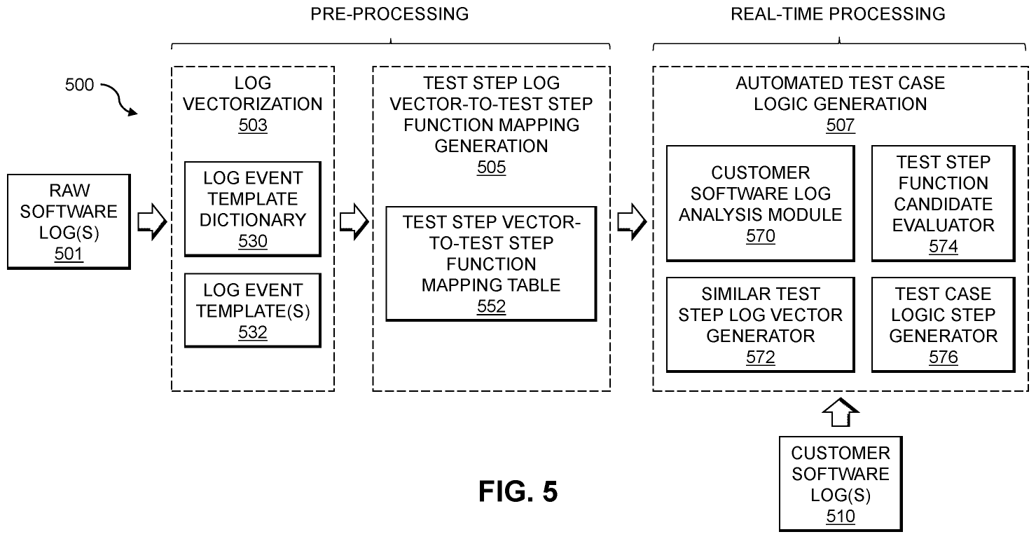

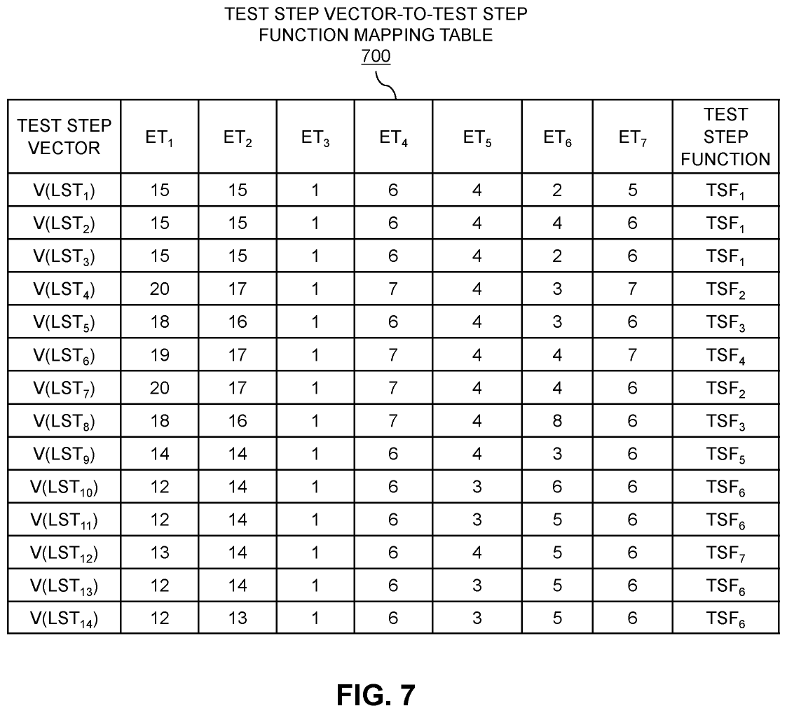

FIG. 5 shows an overall process flow 500 for automated generation of software application test cases for evaluation of software application issues in an illustrative embodiment. The process flow 500 begins with a set of raw software logs 501, which are pre-processed in a log vectorization stage 503 and a test step log vector-to-test step function mapping generation stage 505. In the log vectorization stage 503, a log event template dictionary 530 (e.g., in a similar manner as the log event template dictionary 400 of FIG. 4) is used to parse the raw software logs 501 to identify a set of log event templates 532 (e.g., as shown and described above in conjunction with FIG. 5). The process flow 500 then proceeds to the test step log vector-to-test step function mapping generation stage 505 that processes vector representations of test step log templates, V(LST), sometimes referred to herein as test step vectors, and generates a test step vector-to-test step function mapping table 552 that maps such test step vectors to test step automation functions, TSF. In at least some embodiments, the test step vector-to-test step function mapping table 552 is generated by performing a regression analysis on a historical test case execution log, for example, as discussed further below in conjunction with FIG. 7. The test step vector-to-test step function mapping table 552 is sometimes referred to herein as a mapping function, M, expressed as follows:

$${TSF}_{{LST}_{K}} = M ( V ( {LST}_{K} ) ) .$$

where TSF refers to a test step automation function of a given test step log template, LST_{K}, denoted as TSF_{LST}_{_{K′}}.

In a real-time processing phase, for example, in response to a customer reporting an issue (e.g., one or more software errors and/or bugs) with respect to a given software product, the process flow 500 comprises an automated test case logic generation stage 507. In the automated test case logic generation stage 507, one or more customer software logs 510 are processed by a customer software log analysis module 570 that obtains test step log vectors from the customer software log, in a similar manner as described above in the pre-processing phase (e.g., because the customer software logs for a given software product are typically substantially similar to the raw software logs 501 associated with the given software product), as follows:

$${LT}_{C} = [ \begin{matrix}{LST}_{1} \\ ⋮ \\ {LST}_{m}\end{matrix} ] .$$

In addition, a similar test step log vector generator 572 identifies a top N (e.g., N=10) set of similar vectors of a given test step vector V(LSTᵢ) (vector representation of the ith test step log template) in a vector space T, for example, using an approximate nearest neighbors approach, such as Annoy, denoted as Annoy (V(LSTᵢ)=[v₁, v₂, v₃, . . . v₁₀]. The top 10 similar vectors in the vector space T comprise test step function candidates, TSF_{C}, and may be distant from a target vector (e.g., the customer issue log vector). The test step function candidates, TSF_{C}, may be expressed, as follows:

$${TSF}_{C} = [ M ( {v}_{1} ) , M ( {v}_{2} ) , M ( {v}_{3} ) , … . M ( {v}_{10} ) ] ,$$

where the mapping function, M, is based on the test step vector-to-test step function mapping table 552.

The test step function candidates, TSF_{C}, may be evaluated in some embodiments by a test step function candidate evaluator 574 that selects a given test step function from the test step function candidates, TSF_{C}, for example, based on the test step function candidate, TSF_{C}, having a highest appearance count (e.g., the test step function candidate, TSF_{C}, that appears most among the test step function candidates, TSF_{C}, as follows:

$${TSF}_{{LST}_{i}} = M ( {v}_{j} ) ( count ( M ( {v}_{j} ) ) == Maxium [ count ( M ( {v}_{1} ) ) , … count ( M ( {v}_{10} ) ) ] .$$

In the output list, each TSF candidate number is counted and the candidate TSF having the maximum count can be marked as the target TSF (e.g., if the log is similar, then the corresponding TSF should be the same). If all TSFs have a count of one, however, then the top N similar vectors are far away from the target vector, and a new TSF is added to the test step vector-to-test step function mapping table 552.

A test case logic step generator 576 aggregates the selected TSF for each test step log template identified in the customer software log to generate a set of test case logic steps, as follows:

$$TC ( {LT}_{C} ) = [ \begin{matrix}{TSF}_{{LST}_{i}} \\ ⋮ \\ {TSF}_{{LST}_{m}}\end{matrix} ] .$$

The set of test case logic steps, TC(LT_{C}), can be executed to reproduce the identified customer issue. In some embodiments, the software logs are also processed to extract hardware configuration information for the customer environment, and the set of test case logic steps, TC(LT_{C}), can be executed on one or more most similar hardware devices.

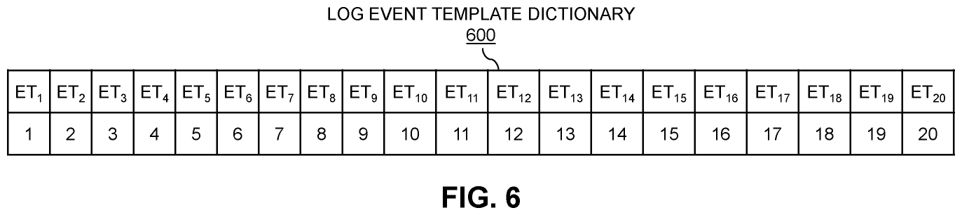

FIG. 6 illustrates an exemplary log event template dictionary 600 in an illustrative embodiment. In the example of FIG. 6, the log event template dictionary 600 comprises 20 unique log event templates. The log event template dictionary 600 may be created in a similar manner as the log event template dictionary 400 of FIG. 4.

FIG. 7 illustrates an exemplary test step vector-to-test step function mapping table 700 in an illustrative embodiment. In the example of FIG. 7, the test step vector-to-test step function mapping table 700 is generated by performing a regression analysis on a historical test case execution log, to identify test step vectors that are associated with test step functions. As noted above, the test step vector-to-test step function mapping table 700 is sometimes referred to herein as a mapping function, M. The test step vector-to-test step function mapping table 700 indicates that the analysis on the historical test case execution log identified 14 test step vectors (LST₁ through LST₁₄) that are each comprised of seven log event templates (ET₁ through ET₇) to describe one test step.

The log event template dictionary 600 and the test step vector-to-test step function mapping table 700 are discussed further below in conjunction with an exemplary generation of software application test cases to evaluate a given software application issue.

It is noted that the same test step function will generate similar test logs (although not exactly the same), for example, due to differences in the execution environment. Thus, FIG. 7 shows that the test step vectors (V(LST₁), V(LST₂), V(LST₃)) all map to TSF₁.

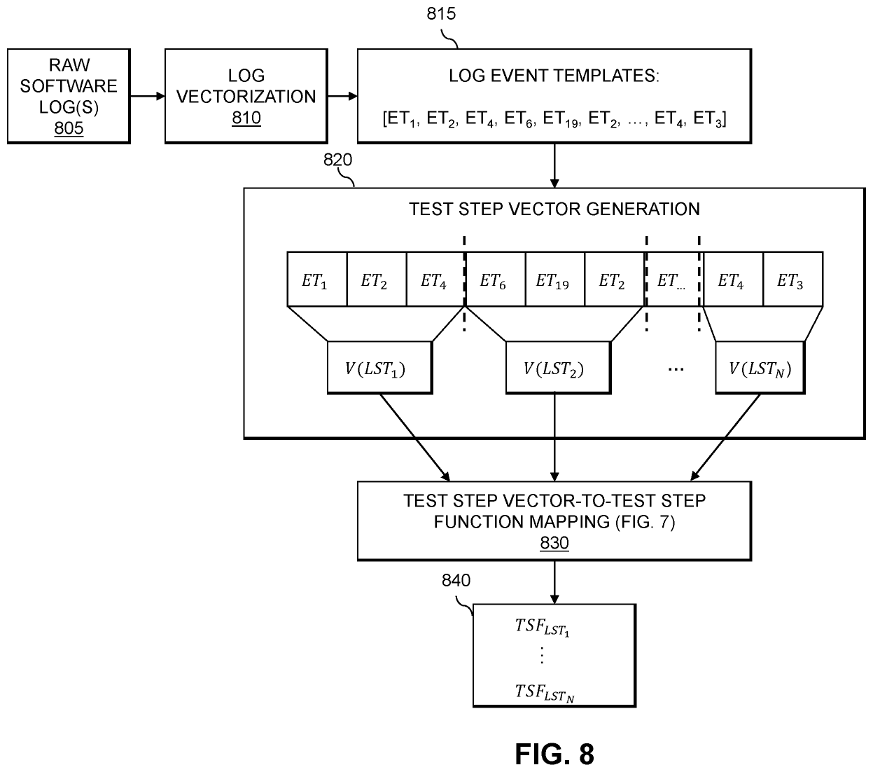

FIG. 8 illustrates a processing of one or more raw software logs 805 to generate the test step vector-to-test step function mapping table of FIG. 7 in an illustrative embodiment. In the example of FIG. 8, the one or more raw software logs 805 are processed by a log vectorization process 810, for example, using the log event template dictionary 600 of FIG. 6, to generate corresponding log event templates 815 [e.g., ET₁, ET₂, ET₄, ET₆, ET₁₉, ET₂, . . . , ET₄, ET₃]. A test step vector generation process 820 processes the log event templates 815 to generate corresponding test step vectors (V(LST₁), V(LST₂), . . . . V(LST_{N})) by grouping one or more individual log event templates into test steps, as discussed above.

The test step vectors generated by the test step vector generation process 820 are then translated into test step functions 840 using a test step vector-to-test step function mapping process 830, as discussed above in conjunction with FIG. 7.

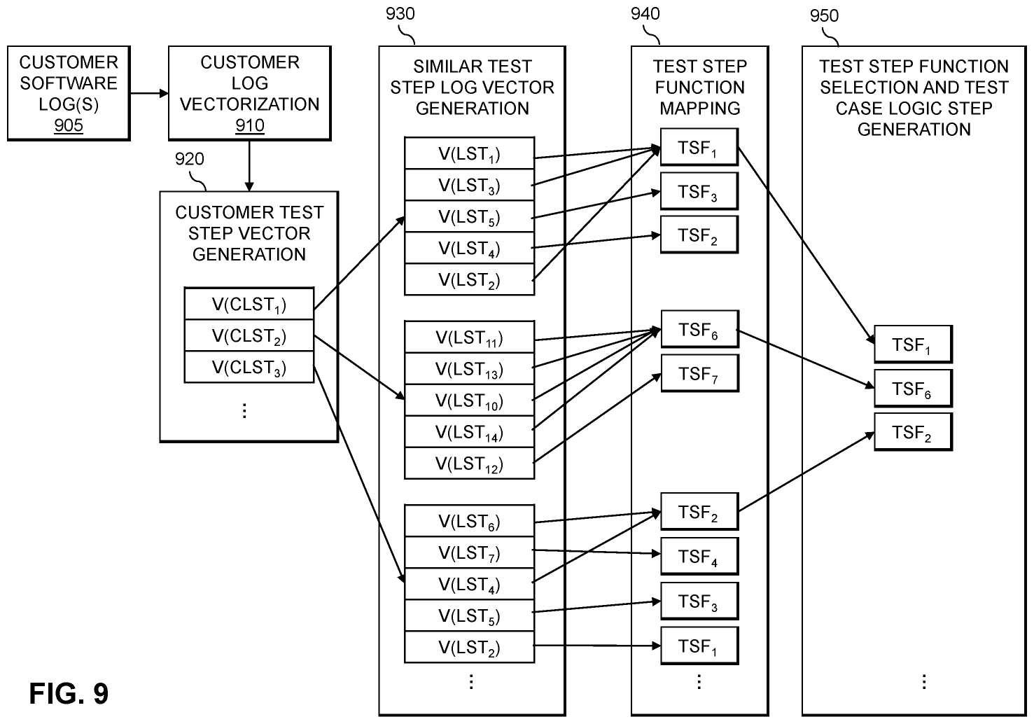

FIG. 9 illustrates a processing of one or more customer software logs 905 (e.g., logs generated from an execution of a given software application in a customer environment) to generate a test case logic flow that evaluates a reported software issue related to a given software application in an illustrative embodiment. In the example of FIG. 9, the one or more customer software logs 905 are processed by a customer log vectorization process 910, for example, using the log event template dictionary 600 of FIG. 6, and the test step vector generation process 820 of FIG. 8, to generate corresponding customer test step vectors (V(CLST₁), V(CLST₂), V(LST₃) . . . ) by grouping one or more individual log event templates into test steps, as discussed above.

In addition, a similar test step log vector generation process 930 identifies a top N (e.g., N=5) set of similar vectors of a given customer test step vector V(CLSTᵢ) (e.g., a vector representation of the ith customer test step log template) in a vector space T, for example, using an Annoy approximate nearest neighbors approach, denoted as Annoy (V(CLSTᵢ))=[v₁, v₂, v₃, . . . v₅]. The top five similar vectors in the vector space T comprise test step function candidates, TSF_{C}, and may be distant from a target vector (e.g., the customer issue log vector). The test step function candidates, TSF_{C}, may be expressed, as follows:

$${TSF}_{C} = [ M ( {v}_{1} ) , M ( {v}_{2} ) , M ( {v}_{3} ) , … . M ( {v}_{10} ) ] .$$

In the example of FIG. 9, the five test step log vectors that are similar to each of the customer test step vectors (V(CLST₁), V(CLST₂), V(LST₃) . . . ) are identified. Thereafter, a test step function mapping process 940 is applied to the five similar test step log vectors for each of the customer test step vectors. A test step function selection and test case logic step generation process 950 selects a given test step function from the test step function candidates generated by the test step function mapping process 940, for example, based on the test step function candidate, TSF_{C}, having a highest appearance count, as discussed above. The similarity, test step function mapping and test step function selection for the first three customer test step vectors (V(CLST₁), V(CLST₂), V(LST₃) . . . ) may be expressed, as follows:

$$Annoy Similarity for V ( {CLST}_{1} ) : ( V ( {CLST}_{1} ) ) =$$

$$print ( AnnoyIndex ( V ( {LST}_{i} ) ) . get\_nns \_by \_item ( Index ( V ( {CLST}_{1} ) ) , 5 ) ) =$$

$$[ V ( {CLST}_{1} ) , V ( {LST}_{1} ) , V ( {LST}_{3} ) , V ( {LST}_{5} ) , V ( {LST}_{4} ) , V ( {LST}_{2} ) ]$$

$$Test Step Function Mapping for V ( {CLST}_{1} ) :$$

$$M [ V ( {CLST}_{1} ) , V ( {LST}_{1} ) , V ( {LST}_{3} ) , V ( {LST}_{5} ) , V ( {LST}_{4} ) , V ( {LST}_{2} ) ] =$$

$$[ {TSF}_{1} , {TSF}_{1} , {TSF}_{3} , {TSF}_{2} , {TSF}_{1} ]$$

$$Test Step Function Selection for V ( {CLST}_{1} ) : {TSF}_{{CLST}_{1}} = {TSF}_{1}$$

$$Annoy Similarity for V ( {CLST}_{2} ) : ( V ( {CLST}_{2} ) ) =$$

$$[ V ( {CLST}_{2} ) , V ( {LST}_{11} ) , V ( {LST}_{13} ) , V ( {LST}_{10} ) , V ( {LST}_{14} ) , V ( {LST}_{12} ) ]$$

$$Test Step Function Mapping for V ( {CLST}_{2} ) :$$

$$M [ V ( {CLST}_{2} ) , V ( {LST}_{11} ) , V ( {LST}_{13} ) , V ( {LST}_{10} ) , V ( {LST}_{14} ) , V ( {LST}_{12} ) ] =$$

$$[ {TSF}_{6} , {TSF}_{6} , {TSF}_{6} , {TSF}_{6} , {TSF}_{7} ]$$

$$Test Step Function Selection for V ( {CLST}_{2} ) : {TSF}_{{CLST}_{2}} = {TSF}_{6}$$

$$Annoy Similarity for V ( {CLST}_{3} ) : ( V ( {CLST}_{3} ) ) =$$

$$[ V ( {CLST}_{2} ) , V ( {LST}_{6} ) , V ( {LST}_{7} ) , V ( {LST}_{4} ) , V ( {LST}_{5} ) , V ( {LST}_{2} ) ]$$

$$Test Step Function Mapping for V ( {CLST}_{3} ) :$$

$$M [ V ( {CLST}_{2} ) , V ( {LST}_{7} ) , V ( {LST}_{6} ) , V ( {LST}_{4} ) , V ( {LST}_{5} ) , V ( {LST}_{2} ) ] =$$

$$[ {TSF}_{2} , {TSF}_{4} , {TSF}_{2} , {TSF}_{3} , {TSF}_{1} ]$$

$$Test Step Function Selection for V ( {CLST}_{3} ) : {TSF}_{{CLST}_{3}} = {TSF}_{2}$$

As noted above the test step function selection and test case logic step generation process 950 selects a given test step function from the test step function candidates generated by the test step function mapping process 940. In addition, the test step function selection and test case logic step generation process 950 also collects the selected test step functions for each customer test step vector (V(CLSTᵢ)), as a set of test case logic steps, as follows:

$$TC ( {LT}_{C} ) = [ \begin{matrix}{TSF}_{1} \\ {TSF}_{6} \\ {TSF}_{2}\end{matrix} ] .$$

The generated set of test case logic steps (TC(LT_{C})) may be executed to evaluate the reported customer software issue.

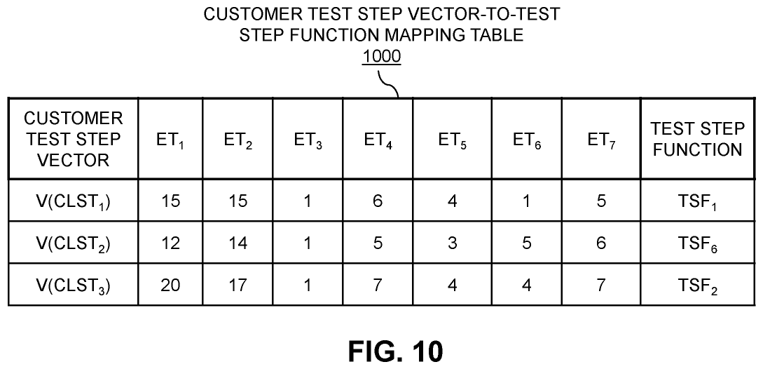

FIG. 10 illustrates an exemplary customer test step vector-to-test step function mapping table 1000 in an illustrative embodiment. In the example of FIG. 10, the customer test step vector-to-test step function mapping table 1000 reflects the test step function selection for each customer test step vector (V(CLSTᵢ)), as discussed above in conjunction with the example of FIG. 9. The customer test step vector-to-test step function mapping table 1000 indicates that the analysis on the test case execution log identified three customer test step vectors (LST₁ through LST₃) that are each comprised of seven log event templates (ET₁ through ET₇) to describe one test step. The test step functions [TSF₁, TSF₆, TSF₂] shown in FIG. 10 are generated by the test step function selection and test case logic step generation process 950 of FIG. 9.

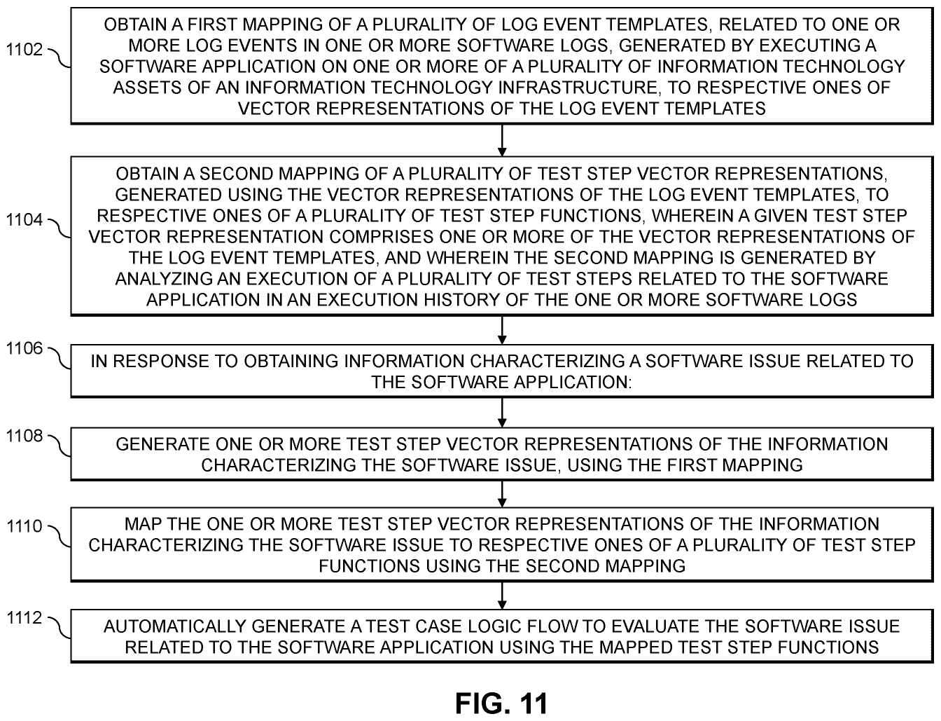

FIG. 11 is a flow diagram illustrating an exemplary implementation of a process for automated generation of software application test cases for evaluation of software application issues, according to an embodiment. In the example of FIG. 11, a first mapping is obtained in step 1102 of a plurality of log event templates, related to one or more log events in one or more software logs, generated by executing a software application on one or more of a plurality of information technology assets of an information technology infrastructure, to respective ones of vector representations of the log event templates.

A second mapping is obtained in step 1104 of a plurality of test step vector representations, generated using the vector representations of the log event templates, to respective ones of a plurality of test step functions, wherein a given test step vector representation comprises one or more of the vector representations of the log event templates, and wherein the second mapping is generated by analyzing an execution of a plurality of test steps related to the software application in an execution history of the one or more software logs.

In response to obtaining information in step 1106 characterizing a software issue related to the software application, one or more test step vector representations of the information characterizing the software issue are generated in step 1108, using the first mapping. The one or more test step vector representations of the information characterizing the software issue are mapped in step 1110 to respective ones of a plurality of test step functions using the second mapping. A test case logic flow is automatically generated in step 1112 to evaluate the software issue related to the software application using the mapped test step functions.

In some embodiments, the first mapping is implemented using a log event template dictionary (e.g., the log event template dictionary 400 of FIG. 4) that is generated by: obtaining software logs generated by executing the software application on information technology assets; parsing the software logs to generate the log event templates to represent respective log events in the software logs; and generating the vector representation of the log event templates. The parsing the software logs to generate the log event templates to represent respective log events in the software logs may comprise identifying log events in the software logs; and for each of the log events in the software logs, extracting constant portions (e.g., and discarding variable portions) and converting the extracted constant portions of the log events in the software logs to a given log event template.

In at least one embodiment, the software logs comprise: execution logs generated by the execution of the software application; and/or user logs generated in conjunction with execution of the software application by users (for example, in a customer environment). The user logs may comprise at least some of the information characterizing the software issue related to the software application.

In one or more embodiments, the given test step vector representation is generated by aggregating one or more of the vector representations of the log event templates (for example, as discussed in conjunction with FIG. 8). The generating the test step vector representations of the information characterizing the software issue may comprise parsing the information to generate log event templates to represent respective log events in the information; and generating vector representations of the log event templates, using the first mapping (e.g., in the form of a log event template dictionary). In addition, the generating the test step vector representations of the information characterizing the software issue may further comprise: identifying one or more additional test step vector representations based on a similarity metric for at least some of the test step vector representations (for example, using the similar test step log vector generation 930 of FIG. 9), mapping the one or more additional test step vector representations associated with a given test step vector representation of the information to a set of corresponding test step functions (for example, using the test step mapping 940 of FIG. 9) and selecting a given test step function from the set of corresponding test step functions for the given test step vector representation of the information (for example, using the test step function selection 950 of FIG. 9).

The particular processing operations and other network functionality described in conjunction with FIGS. 5, 8, 9 and 11, for example, are presented by way of illustrative example only, and should not be construed as limiting the scope of the disclosure in any way. Alternative embodiments can use other types of processing operations to provide functionality for automated generation of software application test cases for evaluation of software application issues. For example, the ordering of the process steps may be varied in other embodiments, or certain steps may be performed concurrently with one another rather than serially. In one aspect, the process can skip one or more of the actions. In other aspects, one or more of the actions are performed simultaneously. In some aspects, additional actions can be performed.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for automated generation of software application test cases for evaluation of software application issues will now be described in greater detail with reference to FIGS. 12 and 13. Although described in the context of information processing system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100 in FIG. 1. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. A hypervisor platform may be used to implement a hypervisor within the virtualization infrastructure 1204, where the hypervisor platform has an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of information processing system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of information processing system 100 and includes a plurality of processing devices, denoted 1302-1, 1302-2, 1302-3, . . . 1302-K, which communicate with one another over a network 1304.

The network 1304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1302-1 in the processing platform 1300 comprises a processor 1310 coupled to a memory 1312.

The processor 1310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1312 may comprise random access memory (RAM), read-only memory (ROM), flash memory or other types of memory, in any combination. The memory 1312 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1314, which is used to interface the processing device with the network 1304 and other system components, and may comprise conventional transceivers.

The other processing devices 1302 of the processing platform 1300 are assumed to be configured in a manner similar to that shown for processing device 1302-1 in the figure.

Again, the particular processing platform 1300 shown in the figure is presented by way of example only, and information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for automated generation of software application test cases for evaluation of software application issues as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, software logs, test cases, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
obtaining a first mapping of a plurality of log event templates, related to one or more log events in one or more software logs, generated by executing a software application on one or more of a plurality of information technology assets of an information technology infrastructure, to respective ones of vector representations of the log event templates;
obtaining a second mapping of a plurality of test step vector representations, generated using the vector representations of the log event templates, to respective ones of a plurality of test step functions, wherein a given test step vector representation comprises one or more of the vector representations of the log event templates, and wherein the second mapping is generated by analyzing an execution of a plurality of test steps related to the software application in an execution history of the one or more software logs;
in response to obtaining information characterizing a software issue related to the software application:
generating one or more test step vector representations of the information characterizing the software issue, using the first mapping;
mapping the one or more test step vector representations of the information characterizing the software issue to respective ones of a plurality of test step functions using the second mapping; and
automatically generating a test case logic flow to evaluate the software issue related to the software application using the mapped test step functions;
wherein the method is performed by at least one processing device comprising a processor coupled to a memory.

2. The method of claim 1, wherein the first mapping is implemented using a log event template dictionary that is generated by:
obtaining one or more software logs generated by executing the software application on one or more of the plurality of information technology assets of the information technology infrastructure;
parsing the one or more software logs to generate the plurality of log event templates to represent respective ones of log events in the one or more software logs; and
generating the vector representation of the plurality of log event templates.

3. The method of claim 2, wherein the parsing the one or more software logs to generate the plurality of log event templates to represent respective ones of log events in the one or more software logs comprises identifying a plurality of log events in the one or more software logs; and
for each of the plurality of log events in the one or more software logs, extracting constant portions and converting the extracted constant portions of each of the plurality of log events in the one or more software logs to a given one of a plurality of log event templates.

4. The method of claim 1, wherein the one or more software logs comprise at least one of:
one or more execution logs generated by the execution of the software application; and
one or more user logs generated in conjunction with execution of the software application by one or more users.

5. The method of claim 4, wherein the one or more user logs comprise at least some of the information characterizing the software issue related to the software application.

6. The method of claim 1, wherein the given test step vector representation is generated by aggregating one or more of the vector representations of the log event templates.

7. The method of claim 1, wherein the generating the one or more test step vector representations of the information characterizing the software issue comprises parsing the information to generate a plurality of log event templates to represent respective ones of log events in the information; and generating vector representations of the plurality of log event templates, using the first mapping.

8. The method of claim 1, wherein the generating the one or more test step vector representations of the information characterizing the software issue further comprises: identifying one or more additional test step vector representations based on a similarity metric for at least some of the one or more test step vector representations, mapping the one or more additional test step vector representations associated with a given test step vector representation of the information to a set of corresponding test step functions and selecting a given test step function from the set of corresponding test step functions for the given test step vector representation of the information.

9. An apparatus comprising:
at least one processing device comprising a processor coupled to a memory;
the at least one processing device being configured to implement the following steps:
obtaining a first mapping of a plurality of log event templates, related to one or more log events in one or more software logs, generated by executing a software application on one or more of a plurality of information technology assets of an information technology infrastructure, to respective ones of vector representations of the log event templates;
obtaining a second mapping of a plurality of test step vector representations, generated using the vector representations of the log event templates, to respective ones of a plurality of test step functions, wherein a given test step vector representation comprises one or more of the vector representations of the log event templates, and wherein the second mapping is generated by analyzing an execution of a plurality of test steps related to the software application in an execution history of the one or more software logs;
in response to obtaining information characterizing a software issue related to the software application:
generating one or more test step vector representations of the information characterizing the software issue, using the first mapping;
mapping the one or more test step vector representations of the information characterizing the software issue to respective ones of a plurality of test step functions using the second mapping; and
automatically generating a test case logic flow to evaluate the software issue related to the software application using the mapped test step functions.

10. The apparatus of claim 9, wherein the first mapping is implemented using a log event template dictionary that is generated by:
obtaining one or more software logs generated by executing the software application on one or more of the plurality of information technology assets of the information technology infrastructure;
parsing the one or more software logs to generate the plurality of log event templates to represent respective ones of log events in the one or more software logs; and
generating the vector representation of the plurality of log event templates.

11. The apparatus of claim 10, wherein the parsing the one or more software logs to generate the plurality of log event templates to represent respective ones of log events in the one or more software logs comprises identifying a plurality of log events in the one or more software logs; and for each of the plurality of log events in the one or more software logs, extracting constant portions and converting the extracted constant portions of each of the plurality of log events in the one or more software logs to a given one of a plurality of log event templates.

12. The apparatus of claim 9, wherein the one or more software logs comprise at least one of:
one or more execution logs generated by the execution of the software application; and
one or more user logs generated in conjunction with execution of the software application by one or more users, wherein the one or more user logs comprise at least some of the information characterizing the software issue related to the software application.

13. The apparatus of claim 9, wherein the generating the one or more test step vector representations of the information characterizing the software issue comprises parsing the information to generate a plurality of log event templates to represent respective ones of log events in the information; and generating vector representations of the plurality of log event templates, using the first mapping.

14. The apparatus of claim 9, wherein the generating the one or more test step vector representations of the information characterizing the software issue further comprises: identifying one or more additional test step vector representations based on a similarity metric for at least some of the one or more test step vector representations, mapping the one or more additional test step vector representations associated with a given test step vector representation of the information to a set of corresponding test step functions and selecting a given test step function from the set of corresponding test step functions for the given test step vector representation of the information.

15. A non-transitory processor-readable storage medium having stored therein program code of one or more software programs, wherein the program code when executed by at least one processing device causes the at least one processing device to perform the following steps:
obtaining a first mapping of a plurality of log event templates, related to one or more log events in one or more software logs, generated by executing a software application on one or more of a plurality of information technology assets of an information technology infrastructure, to respective ones of vector representations of the log event templates;
obtaining a second mapping of a plurality of test step vector representations, generated using the vector representations of the log event templates, to respective ones of a plurality of test step functions, wherein a given test step vector representation comprises one or more of the vector representations of the log event templates, and wherein the second mapping is generated by analyzing an execution of a plurality of test steps related to the software application in an execution history of the one or more software logs;
in response to obtaining information characterizing a software issue related to the software application:
generating one or more test step vector representations of the information characterizing the software issue, using the first mapping;
mapping the one or more test step vector representations of the information characterizing the software issue to respective ones of a plurality of test step functions using the second mapping; and
automatically generating a test case logic flow to evaluate the software issue related to the software application using the mapped test step functions.

16. The non-transitory processor-readable storage medium of claim 15, wherein the first mapping is implemented using a log event template dictionary that is generated by:
obtaining one or more software logs generated by executing the software application on one or more of the plurality of information technology assets of the information technology infrastructure;
parsing the one or more software logs to generate the plurality of log event templates to represent respective ones of log events in the one or more software logs; and
generating the vector representation of the plurality of log event templates.

17. The non-transitory processor-readable storage medium of claim 16, wherein the parsing the one or more software logs to generate the plurality of log event templates to represent respective ones of log events in the one or more software logs comprises identifying a plurality of log events in the one or more software logs; and for each of the plurality of log events in the one or more software logs, extracting constant portions and converting the extracted constant portions of each of the plurality of log events in the one or more software logs to a given one of a plurality of log event templates.

18. The non-transitory processor-readable storage medium of claim 15, wherein the one or more software logs comprise at least one of:
one or more execution logs generated by the execution of the software application; and
one or more user logs generated in conjunction with execution of the software application by one or more users, wherein the one or more user logs comprise at least some of the information characterizing the software issue related to the software application.

19. The non-transitory processor-readable storage medium of claim 15, wherein the generating the one or more test step vector representations of the information characterizing the software issue comprises parsing the information to generate a plurality of log event templates to represent respective ones of log events in the information; and generating vector representations of the plurality of log event templates, using the first mapping.

20. The non-transitory processor-readable storage medium of claim 15, wherein the generating the one or more test step vector representations of the information characterizing the software issue further comprises: identifying one or more additional test step vector representations based on a similarity metric for at least some of the one or more test step vector representations, mapping the one or more additional test step vector representations associated with a given test step vector representation of the information to a set of corresponding test step functions and selecting a given test step function from the set of corresponding test step functions for the given test step vector representation of the information.
